(19) United States
(12) Patent Application Publication
(10) Pub. No.: US 2025/0150165 A1
(43) Pub. Date: May 8, 2025

(54) RADIO LINK MONITORING AND IDLE RADIO RESOURCE MANAGEMENT ENHANCEMENT FOR NON-TERRESTRIAL NETWORKS

(71) Applicant: Apple Inc., Cupertino, CA (US)

(72) Inventors: Jie CUI, San Jose, CA (US); Qiming LI, Beijing (CN); Xiang CHEN, Campbell, CA (US); Yang TANG, San Jose, CA (US); Hong HE, San Jose, CA (US); Haitong SUN, Cupertino, CA (US); Manasa RAGHAVAN, Sunnyvale, CA (US); Dawei ZHANG, Saratoga, CA (US); Qunfeng HE, Beijing (CN); Chunxuan YE, San Diego, CA (US)

(73) Assignee: Apple Inc., Cupertino, CA (US)

(21) Appl. No.: 18/837,554

(22) PCT Filed: Feb. 11, 2022
(86) PCT No.: PCT/CN2022/076044

§ 371 Date: Aug. 9, 2024

(51) Int. Cl. H04B 7/185; H04B 7/19; H04B 7/195; H04W 36/00; H04W 36/24

(52) U.S. Cl. CPC H04B 7/18541; H04B 7/19; H04B 7/195; H04W 36/0058; H04W 36/249

(57) ABSTRACT

Approaches are described to enhance radio link monitoring and link recovery for the integration of non-terrestrial networks (e.g., satellites) into next generation wireless communication networks. Certain approaches describe the modification of block error rate threshold requirements based on the particulars of the satellites involved, and the procedure for making those modifications. Other approaches describe the modification of the evaluation period based on the particulars of the satellites involved, and the procedure for making those modifications. In making these modifications, user-equipment (UE)-specific margins are also considered. In addition, modifications to the procedure for higher priority cell search are also described when non-terrestrial wireless communication networks are involved.

### BACKGROUND

### Field

Various aspects generally may relate to the field of wireless communications.

### SUMMARY

Aspects of the approach described herein include a user equipment (UE). The UE includes a radio frequency (RF) receiver that is configured to receive, via an antenna, an indication of a service stop time of connectivity between the UE and the satellite within the wireless communication network. The UE also includes processing circuitry coupled to the RF receiver, where the processing circuitry is configured to monitoring one or more inter-frequency or inter-RAT carriers in the wireless communication network. The processing circuitry is also configured to, based on the monitoring, switching to another connection in the wireless communication network using one of the one or more inter-frequency or inter-RAT carriers.

Aspects of the approach described herein include a user equipment (UE). The UE includes a radio frequency (RF) receiver that is configured to receive, via an antenna, antenna a downlink radio signal. The UE also includes processing circuitry coupled to the RF receiver, where the processing circuitry is configured to evaluate block error rate (BLER) based on the measured downlink radio link quality. The processing circuitry is also configured to compare the evaluated BLER with at least one of an out-of-sync block error rate threshold (BLERout) or an in-sync block error rate (BLERin), wherein the BLERout or the BLERin are based on a characteristic of the satellite.

Aspects of the approach also include a method by a user equipment (UE) for radio resource measurement (RRM) in an idle mode or an inactive mode in a wireless communication network having a satellite that includes the step of receiving an indication of a service stop time of connectivity between the UE and the satellite within the wireless communication network. The method also includes the step of monitoring one or more inter-frequency or inter-RAT carriers in the wireless communication network. The method includes the step of based on the monitoring, switching to another connection in the wireless communication network using one of the one or more inter-frequency or inter-RAT carriers.

Aspects of the approach also include a method by a user equipment (UE) for radio link monitoring of a connection with a satellite in a wireless communication network that includes the step of measuring downlink radio link quality of the connection during an evaluation period. The method also includes the step of evaluating block error rate (BLER) based on the measured downlink radio link quality. The method includes the step of comparing the evaluated BLER with at least one of an out-of-sync block error rate threshold (BLERout) or an in-sync block error rate (BLERin), wherein the BLERout or the BLERin are based on a characteristic of the satellite.

This Summary is provided merely for purposes of illustrating some aspects to provide an understanding of the subject matter described herein. Accordingly, the above-described features are merely examples and should not be construed to narrow the scope or spirit of the subject matter in this disclosure. Other features, aspects, and advantages of this disclosure will become apparent from the following Detailed Description, Figures, and Claims.

### BRIEF DESCRIPTION OF THE FIGURES

The accompanying drawings, which are incorporated herein and form part of the specification, illustrate the present disclosure and, together with the description, further serve to explain the principles of the disclosure and enable a person of skill in the relevant art(s) to make and use the disclosure.

FIG. 1 illustrates an example system implementing for radio link monitoring of connection between a user equipment (UE) and satellites in a wireless communication network, according to some aspects of the disclosure.

FIG. 2 illustrates a block diagram of an example system of an electronic device for radio link monitoring of connection with satellites, according to some aspects of the disclosure.

FIG. 3A illustrates a flowchart diagram of a method 300 for radio resource management (RRM) of connection with satellites, in accordance with aspects of the present disclosure.

FIG. 3B illustrates a flowchart diagram of a method 300 for radio link monitoring (RLM) of connection with satellites, in accordance with aspects of the present disclosure.

FIG. 4 is an example computer system for implementing some aspects or portion(s) thereof.

The present disclosure is described with reference to the accompanying drawings. In the drawings, generally, like reference numbers indicate identical or functionally similar elements. Additionally, generally, the left-most digit(s) of a reference number identifies the drawing in which the reference number first appears.

### DETAILED DESCRIPTION

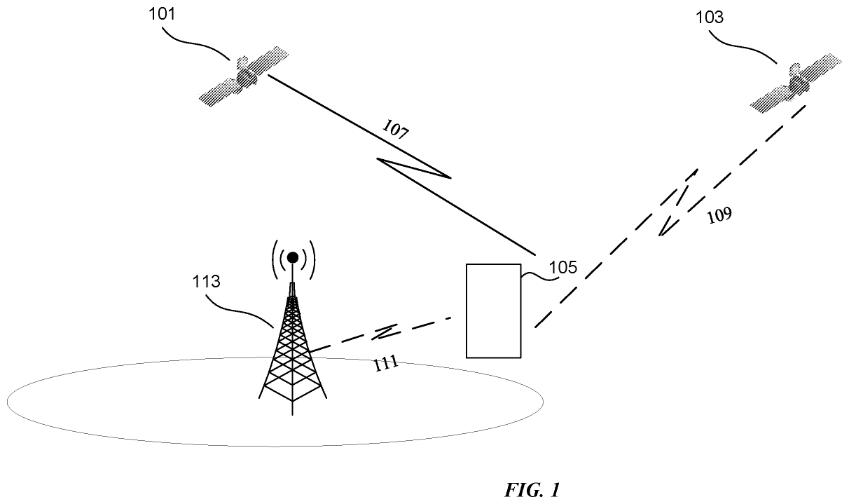

FIG. 1 illustrates an example system implementing mechanisms for radio link monitoring of connections with non-terrestrial networks, according to some aspects of the disclosure. Example system 100 is provided for the purpose of illustration only and does not limit the disclosed aspects. System 100 may include, but is not limited to, network nodes (base stations that are for example, satellites) 101 and 103 and electronic device (for example, a UE) 105. Electronic device 105 (hereinafter referred to as UE 105) can include an electronic device configured to operate based on a wide variety of wireless communication techniques. These techniques can include, but are not limited to, techniques based on 3rd Generation Partnership Project (3GPP) standards. For example, UE 105 can be configured to operate using the 3GPP standards. UE 105 can include, but is not limited to, as wireless communication devices, smart phones, laptops, desktops, tablets, personal assistants, monitors, televisions, wearable devices, Internet of Things (IoTs), vehicle's communication devices, and the like. Network node 101 (herein referred to as a base station) can include nodes configured to operate based on a wide variety of wireless communication techniques such as, but not limited to, techniques based on 3GPP standards.

According to some aspects, UE 105 and satellites 101 and 103 are configured for radio link monitoring. In some aspects, UE 105 is configured for radio link monitoring. According to some aspects, UE 105 can be connected to and can be communicating with satellite 101 (e.g., the serving cell) using carrier 107 from which UE 105 receives the multiple downlink signals.

According to some aspects, UE 105 can measure one or more carriers (e.g., carrier 107) used for communication with satellite 101 (e.g., the serving cell) to perform radio link monitoring. UE 105 can measure one or more carriers (e.g., carrier 109) used for communication with satellite 103 (e.g., a neighboring cell) to perform radio link monitoring. UE 105 can measure one or more carriers (e.g., carrier 111) used for communication with terrestrial base station 113 (e.g., nearby terrestrial cell) to perform radio link monitoring.

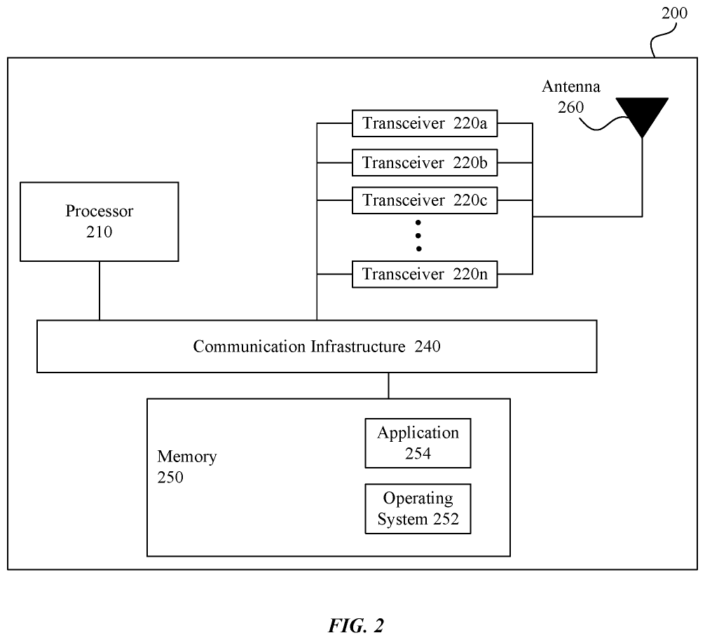

FIG. 2 illustrates a block diagram of an example system 200 of an electronic device implementing mechanisms for radio link monitoring, according to some aspects of the disclosure. System 200 may be any of the electronic devices (e.g., satellites 101, 103, UE 105) of system 100. System 200 includes processor 210, one or more transceivers 220a-220n, communication infrastructure 240, memory 250, operating system 252, application 254, and antenna 260. Illustrated systems are provided as exemplary parts of system 200, and system 200 can include other circuit(s) and subsystem(s). Also, although the systems of system 200 are illustrated as separate components, the aspects of this disclosure can include any combination of these, less, or more components.

Memory 250 may include random access memory (RAM) and/or cache, and may include control logic (e.g., computer software) and/or data. Memory 250 may include other storage devices or memory such as, but not limited to, a hard disk drive and/or a removable storage device/unit. According to some examples, operating system 252 can be stored in memory 250. Operating system 252 can manage transfer of data from memory 250 and/or one or more applications 254 to processor 210 and/or one or more transceivers 220a-220n. In some examples, operating system 252 maintains one or more network protocol stacks (e.g., Internet protocol stack, cellular protocol stack, and the like) that can include a number of logical layers. At corresponding layers of the protocol stack, operating system 252 includes control mechanism and data structures to perform the functions associated with that layer.

According to some examples, application 254 can be stored in memory 250. Application 254 can include applications (e.g., user applications) used by wireless system 200 and/or a user of wireless system 200. The applications in application 254 can include applications such as, but not limited to radio streaming, video streaming, remote control, and/or other user applications.

System 200 can also include communication infrastructure 240. Communication infrastructure 240 provides communication between, for example, processor 210, one or more transceivers 220a-220n, and memory 250. In some implementations, communication infrastructure 240 may be a bus.

Processor 210 together with instructions stored in memory 250 performs operations enabling system 200 of system 100 to implement mechanisms for radio link monitoring, as described herein.

One or more transceivers 220a-220n transmit and receive communications signals that support mechanisms for performing time and/or frequency tracking based on those TRS configurations, according to some aspects, and may be coupled to antenna 260. Antenna 260 may include one or more antennas that may be the same or different types. One or more transceivers 220a-220n allow system 200 to communicate with other devices that may be wired and/or wireless. In some examples, one or more transceivers 220a-220n can include processors, controllers, radios, sockets, plugs, buffers, and like circuits/devices used for connecting to and communication on networks. According to some examples, one or more transceivers 220a-220n include one or more circuits to connect to and communicate on wired and/or wireless networks.

According to some aspects, one or more transceivers 220a-220n can include a satellite subsystem, cellular subsystem, a WLAN subsystem, and/or a Bluetooth™ subsystem, each including its own radio transceiver and protocol(s) as will be understood by those skilled arts based on the discussion provided herein. In some implementations, one or more transceivers 220a-220n can include more or fewer systems for communicating with other devices. The term “satellite” used here include different types of satellites, such as GEO (geostationary earth orbit) satellites and LEO (low earth orbit) satellites.

In some examples, one or more transceivers 220a-220n can include one or more circuits (including a WLAN transceiver) to enable connection(s) and communication over WLAN networks such as, but not limited to, networks based on standards described in IEEE 802.11. Additionally, or alternatively, one or more transceivers 220a-220n can include one or more circuits (including a Bluetooth™ transceiver) to enable connection(s) and communication based on, for example, Bluetooth™ protocol, the Bluetooth™ Low Energy protocol, or the Bluetooth™ Low Energy Long Range protocol. For example, transceiver 220n can include a Bluetooth™ transceiver.

Additionally, one or more transceivers 220a-220n can include one or more circuits (including a cellular transceiver) for connecting to and communicating on cellular networks. The cellular networks can include, but are not limited to, 3G/4G/5G networks such as Universal Mobile Telecommunications System (UMTS), Long-Term Evolution (LTE), and the like. For example, one or more transceivers 220a-220n can be configured to operate according to one or more of Rel-15, Rel-16, Rel-17, or other of the 3GPP standard.

In addition, one or more transceivers 220a-220n can include one or more circuits for connecting to and communicating with satellite networks. Such satellite networks can include, but are not limited to, wireless communication networks such as 3G/4G/5G networks such as Universal Mobile Telecommunications System (UMTS), Long-Term Evolution (LTE), as well as specific satellite communications network protocols for gateway functionality and control functionality from satellite ground stations. For example, one or more transceivers 220a-220n can be configured to operate according to one or more of Rel-15, Rel-16, Rel-17, or other of the 3GPP standard. In addition, for LEO-earth-fixed types of satellites (see below), additional capability is provided to steer beams towards fixed points on the Earth's surface by either beamforming or by a mechanically steerable beam approach.

According to some aspects, processor 210, alone or in combination with computer instructions stored within memory 250, and/or one or more transceiver 220a-220n, implements radio link monitoring, as discussed herein. For example, transceiver 220a can enable connection(s) and communication over a first carrier (for example, carrier 107 of FIG. 1). In this example, transceiver 220a and/or transceiver 220b can enable reception of signaling of TRS configuration information (for example, carrier 109 of FIG. 1). Additionally, or alternatively, wireless system 200 can include one transceiver configured to operate at different carriers. Processor 210 can be configured to control the one transceiver to switch between different carriers, according to some examples. Although the operations discussed herein are discussed with respect to processor 210, it is noted that processor 210, alone or in combination with computer instructions stored within memory 250, and/or one or more transceiver 220a-220n, can implement these operations.

### Overview of Radio Link Monitoring Approach in a Non-Terrestrial Network

In the on-going development of wireless systems, there are on-going needs to expand wireless communication capabilities with a view to greater coverage of such capabilities and increased data rates. Given these needs, satellite networks may be used to supplement terrestrial networks (such as LTE and NR networks) and thereby provide connectivity to remote areas and those areas lacking high data rate services. These services and connectivity include backhaul, transportation, outdoor service, and IoT. In adding these additional capabilities, there are unique challenges to the radio link monitoring (RLM) of the connection between a UE and a satellite so that the service is seamless and meets the performance expectations of such a service.

In supplementing terrestrial networks with satellites (non-terrestrial networks), the principle of RLM needs to comparable to that used in terrestrial networks. The purpose of RLM is to monitor the radio link quality of the UE's serving cell and use that information to determine whether the UE is in-sync (IS) or out-of-sync (OOS) with respect to that serving cell. In terrestrial networks, RLM is performed by the UE measuring downlink reference signals. If the measurements indicate a number of consecutive OOS conditions, then the UE may declare a failure condition in the communication. The RLM procedure is performed by comparing the reference signal measurements to threshold block error rates (BLERs) that are denoted as Qout and Qin. In terrestrial networks, Qout and Qin correspond to the BLER of hypothetical downlink channel transmissions from the serving cell, and have respective typical values of 10% and 2%.

Satellite types that may be considered for inclusion in non-terrestrial networks include GEO (geostationary earth orbit) satellites and LEO (low earth orbit) satellites. A GEO satellite maintains an orbit that is approximately 35,000 km above sea level, and appears stationary to a UE on the earth. A LEO satellite maintains an orbit that is between 350 km and 2,000 km above sea level. Because of a LEO satellite's proximity to Earth, it has lower latency and less power needed for signal transmission to and from the satellite results. There are two types of LEO satellite-based cells, LEO-earth-fixed and LEO-earth-moving cells. In the LEO-earth-fixed type, the cell is fixed and the UE inside this fixed cell will have a certain coverage time by the satellite. In order to increase the coverage time, an LEO-earth-fixed type of satellite has the ability to steer beams towards fixed points on the Earth's surface. This ability can be achieved by either beamforming or by a mechanically steerable beam approach. In the case of an LEO-earth-moving type of satellite, the associated cell will move at the same speed as the satellite itself. Thus, the UEs that are inside a particular cell will constantly change, resulting a constant entry and exit of UEs that are covered by that cell of the LEO-earth-moving satellite. The advantage of this type of satellite is that it is less expensive, in that it does not have the additional complexity of the beamforming or mechanically steerable beam capability.

In describing the approaches to support non-terrestrial networks, discussion will include modifications of BLER thresholds and modifications of the evaluation period for radio link monitoring in support of the challenges of connections to satellites. Radio link monitoring by a UE in an idle/inactive mode requires that the UE be able to detect, measure, and evaluate neighbor cells before the serving cell stops serving the area. In certain approaches, such monitoring may be achieved by relying on the serving cell service time information being broadcasted to the UE. The specifics of exemplary approaches are described below, including the timing and measurement details, as well as the impact of satellite-distance considerations. In particular, the BLER thresholds and evaluation determinations for radio link monitoring in non-terrestrial scenarios are described. In addition, the K factor determination for UE mobility based on cell serving time in the idle/inactive mode are also described. Further, a margin consideration for satellite-UE distance and the K and M-layer design for non-terrestrial network scenarios are also described.

### Radio Link Monitoring Enhancement for Non-Terrestrial Networks (NTN)

Radio link monitoring in a wireless communications network requires an on-going estimate of the quality of the connection. Factors that can affect the quality of a connection include wireless signal propagation conditions, noise, and levels of interference. Block error rate (BLER) is a useful metric of the quality of a connection, and is determined as the ratio of the number of erroneous blocks to the total number of transmitted blocks. Thus, a lower ratio (lower BLER) indicates a better connection, while a higher ratio indicates a worse connection. In order to provide actionable monitoring of a connection, such quality estimates are typically compared with thresholds that are appropriate for the connections of interest. For example, in wireless connections, quality estimates may be compared with BLER thresholds or their corresponding signal-to-interference noise ratio (SINR) thresholds. These thresholds are often provided in pairs in order to add hysteresis for switching stability, the thresholds being BLERout and BLERin, and the corresponding Qout and Qin. The signal-to-interference noise ratio (SINR) threshold (Qout) is defined as the level at which the downlink radio link connection signal cannot be reliably received and corresponds to the out-of-sync block error rate (BLERout). The SINR threshold (Qin) is defined as the level at which the downlink radio link quality can be received with significantly higher reliability than at Qout, and corresponds to the in-sync block error rate (BLERin). In a terrestrial network, the BLERin threshold may be set at 2% and the BLERout threshold may be set at 10%.

The BLER thresholds (BLERout and BLERin) determination for radio link monitoring of connections in a non-terrestrial network may be are as follows. In a baseline approach, the BLER thresholds used for radio link monitoring (RLM) may be the same threshold as that for terrestrial networks. In an embodiment for non-terrestrial networks, the BLERin threshold may be set at 2% and the BLERout threshold may be set at 10%. However, such an approach does not take into account any considerations that are relevant to non-terrestrial networks, or to the pragmatic application of those considerations in commercial non-terrestrial wireless networks.

Various options for enhancements applicable to non-terrestrial wireless networks are as follows. In the first option, the UE uses satellite-specific BLER thresholds for radio link monitoring in connections in a non-terrestrial wireless networks. In this option, the satellite-specific BLER thresholds may be predefined in the relevant wireless communications specification (e.g., 3GPP specification). Examples of this first option are that the BLER thresholds for GEO connections or LEO-earth-fixed connections could be same as the thresholds for terrestrial network connections, e.g., BLERout set to 10%, and BLERin set to 2%. In other examples of this first opinion, the BLER thresholds for LEO-earth-moving may be set to lower BLERout and higher BLERin values compared with the thresholds for terrestrial network connections, e.g., BLERout<10%, and BLERin>2%. In still further examples of this first option, in LEO-earth-moving scenarios, the BLER thresholds (BLERout and BLERin) may be set to be different for different speed levels of the serving satellite. For example, for LEO-earth-moving scenarios with satellite speeds higher than X km/h, thresholds BLERout1 and BLERin1 may be used, and for LEO-earth-moving scenarios with satellite speeds lower than or equal to X km/h, thresholds BLERout2 and BLERin2 may be used, where BLERout1<BLERout2<10%, and BLERin1>BLERin2>2% in a specific example. In these examples, indications of the speed of the associated satellite may be provided to the UE so that the UE may determine the relevant BLER thresholds to use.

In a second option, the wireless communication network indicates the relevant BLER thresholds to UE based on the associated satellite type and/or characteristics. In examples of this second option, the network configures the BLER thresholds for the UE based on the satellite type and/or characteristics. For the same satellite type, e.g., LEO-earth-moving, the network could further configure BLER thresholds associated with different speed levels of the satellite. For example, for a LEO-earth-moving satellite scenario with a satellite speed higher than X km/h, the thresholds BLERout1 and BLERin1 are configured, while for a LEO-earth-moving scenario with a satellite speed lower than or equal to X km/h, the thresholds BLERout2 and BLERin2 are configured. In a specific example of this second option, BLERout1<BLERout2<10%, and BLERin1>BLERin2>2%.

### Radio Link Monitoring Evaluation Period for Non-Terrestrial Networks (NTN)

For radio link monitoring, the evaluation period is the period used for in-sync (IS) and out-of-sync (OOS) evaluation in support of SINR measurement and BLER evaluation. Various options for enhancements in the evaluation period applicable to non-terrestrial wireless networks are as follows.

In a first option, the UE may reduce the evaluation period based on the type of satellite in the non-terrestrial wireless network. In one example of this option, this satellite-type evaluation period may be predefined in the wireless communication specification (e.g., 3GPP specification). In one example, the IS and OOS evaluation period for a GEO satellite or a LEO-earth-fixed satellite may be predefined to be the same as that used in a terrestrial network. In another example, the IS and OOS evaluation period for LEO-earth-moving satellite may be reduced to be a smaller time period to that used in a terrestrial network. In further examples of this first option, for LEO-earth-moving satellite scenario, the IS and OOS evaluation period could be different for different speed levels of this satellite. For example, for a LEO-earth-moving satellite scenario with a satellite speed higher than X km/h, a first evaluation period may be used, while for a LEO-earth-moving satellite scenario with a satellite speed lower than or equal to X km/h, a second evaluation period may be used, where the first evaluation period is less than or equal to the second evaluation period.

In a second option, the wireless communications network may indicate the evaluation period to be used by the UE through the use of scaling factors applied to the evaluation period used in a terrestrial network. These scaling factors, which are less than 1, may be different for different satellite types. Satellite types include, for example, a GEO satellite, a LEO-earth-fixed satellite, or a LEO-earth-moving satellite. In addition to different scaling factors that are different for different satellite types, different scaling factors may be used for different speed levels of the satellite. Scaling factors that are based on both satellite type and satellite speed may also be used.

### Measurement Based on Cell Service Time in Non-Terrestrial Networks

From a network planning perspective, the wireless network needs to guarantee that there is sufficient time to perform the required monitoring through the intra-frequency and the inter-frequency/radio-access-technology (RAT) measurements. The time span available begins with the last slot of system information (SI) transmission within SI modification period where the broadcasting of ‘serving cell stop time’ is started and continues until the first slot when the cell is scheduled to stop serving the area according to the broadcasted information. The time needed to perform the measurements is given by Tdetect,NR_Intra and K*Tdetect,NR_Inter. If the time span available is insufficient to provide the needed time, the UE may drop the inter-frequency/inter-RAT (radio access technology) measurements. In this context, Tdetect,NR_Intra is the detection time for the intra-frequency carriers, Tdetect,NR_Inter is the detection time for inter-frequency and inter-RAT carriers, and K is the number of inter-frequency and inter-RAT carriers to monitor at the UE.

There are several options by which the UE can perform the required monitoring in non-terrestrial networks. In the first option, K counts only for the higher priority carrier number of inter-frequency and inter-RAT, where the term “higher priority” is defined in the wireless communication specification (e.g., 3GPP specification).

In the second option, K is indicated by wireless communication network regardless of higher priority carrier number of inter-frequency and inter-RAT.

In the third option, K is also indicated by the wireless communication network. If K is greater than higher priority carrier number of the inter-frequency and inter-RAT, UE may implement inter-frequency and inter-RAT measurement for all higher priority carriers and randomly choose the balance (i.e., K—higher_priority_carrier_number) for other equal or lower priority carriers. If K is smaller than higher priority carrier number of inter-frequency and inter-RAT. UE could implement inter-frequency and inter-RAT measurement for K random higher priority carriers.

In the fourth option, K is predefined in the wireless communication specification (e.g., 3GPP specification) and is chosen as one value from the set of K=1,2,3.

In the fifth option, K is determined differently for different types of satellites, where the types of satellites include: “GEO or LEO earth fixed” (taking the value K1) and “LEO earth moving” (taking the value K2). In this option, K=K1+K2, where K1 and K2 may be indicated by the wireless communication network, or a network indicates the target carriers directly (i.e., which K1 carriers and which K2 carriers to monitor), or be predefined in the wireless communications specification.

### Relaxation on Cell Reselection Margin

Turning to cell reselection margins, if the distance is used as a reselection triggering condition, the distance margin may be artificially added to trigger the reselection. In this case, distance margin means, for example, the distance between UE and serving satellite is greater than a threshold, and/or the distance between UE and neighbor satellite is less than a threshold. These thresholds that are used to determine the distance margins may be provided by indications by the wireless communications network. The UE may implement margins that are added on top of the thresholds to determine if the cell reselection should be triggered or not.

In the first option, the UE determines the margin based on UE global navigation satellite system (GNSS) estimation error and satellite positioning estimation error. Here, the satellite positioning estimation error is based on the ephemeris error and the propagator model error.

In the second option, the margin is predefined in the wireless communication specification (e.g., 3GPP specification), and in certain examples of this second option, may be different for different satellite types. For example, the satellite types include “GEO or LEO-earth-fixed” and “LEO-earth-moving.”

In the third option, the margin is indicated by wireless communications network or multiple distance thresholds are configured by network. Here, in certain examples of the third option, the indicated margins or the multiple configured distance thresholds may be different between different types of satellites, which include “GEO or LEO-earth-fixed,” “LEO-earth-moving,” and the like.

The following discussion illustrates the UE use of the distance threshold and the margin to determine reselection. In this example, the reselection condition is: the distance between serving satellite and UE is greater than threshold S1, and the distance between target neighbor satellite and UE is less than threshold S2. In this example, and using the first option above, the margins determined by the UE are d1 for S1, and d2 for S2. In this scenario, the UE triggers reselection only when the UE estimates that the distance between the serving satellite and UE is greater than S1+d1 and the UE estimates that the distance between target neighbor satellite and UE is less than S2−d2.

### Higher Priority Cell Search

In a terrestrial wireless communications network, the UE shall search every layer of higher priority at least every Thigher_priority_search=(K*Nlayers) seconds, where Nlayers is the total number of higher priority NR and E-UTRA carrier frequencies that are broadcast in system information (SI), and K=60.

A higher priority cell search for non-terrestrial networks is proposed as follows. In this approach, if the serving cell is a LEO satellite or a LEO-earth-moving satellite, the values of K and Nlayer may be reduced to: K′<60 and Mlayer<Nlayer. Thus, under this approach, the UE in the non-terrestrial network implements a search of every layer of the inter-frequency and inter-RAT higher priority carriers every (K′*Mlayers) seconds. In this approach, the UE is provided with an indication of the type of satellite and derives the values of K′ and Mlayer, or the network provides the values of K′ and Mlayer to the UE.

In this proposed approach, if the serving cell is not provided by a LEO satellite or a LEO-earth-moving satellite, there are several alternative approaches. In the first alternative approach, the values of K and Nlayer used in a terrestrial network may be used for the non-terrestrial network. In the second alternative, the target satellite information is not provided to UE, in which case, there are several sub-alternatives. In the first sub-alternative, the approach uses the same values of K and Nlayer, as used in the terrestrial network. In the second sub-alternative, the serving cell provides only some satellite information (not the full list of satellite information) and the UE monitor/search those satellites whose information has been provided to the UE.

In the third sub-alternative, the UE needs to read system information (SI) from target neighbor satellites and determine the satellite type by itself. Here, if the target neighbor satellites are LEO satellites or LEO-earth-moving satellites, the values of K and Nlayer may be reduced to: K′<60 and Mlayer<Nlayer. Otherwise, the same values of K and Nlayer from the terrestrial network may be used. In another sub-alternative, the UE may choose intermediate values of K and Nlayer, as follows: Kmiddle, and Player, where K′<Kmiddle<60 and Mlayer<Player<Nlayer.

In another sub-alternative, the wireless communications network may directly configure and provide those values of K and Nlayer to the UE. In one example of the direct configuration, the wireless communications network may configure the values of K and Nlayer using scaling factors applied to the values of K and Nlayer used by a terrestrial network.

In a further approach, the satellite information may be provided to the UE. In the first alternative with this approach, if the target neighbor satellites are LEO satellites or LEO-earth-moving satellites, the values of K and Nlayer may be reduced to: K′<60 and Mlayer<Nlayer. Otherwise, the same values of K and Nlayer from the terrestrial network may be used.

In the second alternative of this further approach, if at least one satellite on higher priority carriers is a LEO satellite or a LEO-earth-moving satellite, the values of K and Nlayer may be reduced to: K′<60 and Mlayer<Nlayer.

In the third alternative of this further approach, the wireless communications network directly configures the K and Nlayer scaling factors for all carriers or differently for higher priority carriers. For example, different scaling factors may be provided for LEO satellites and non-LEO satellites.

### Summary of Methods for Radio Resource Management and Radio Link Monitoring in a Non-Terrestrial Network

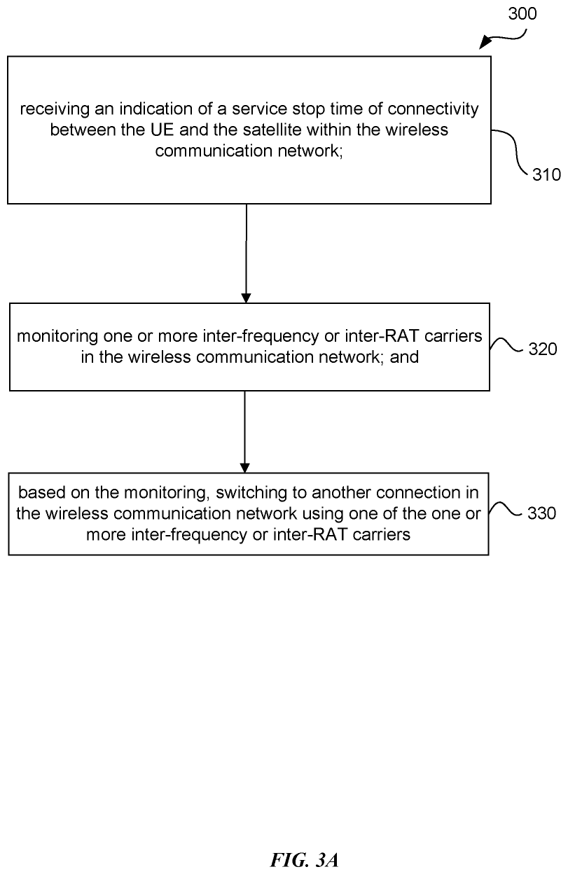

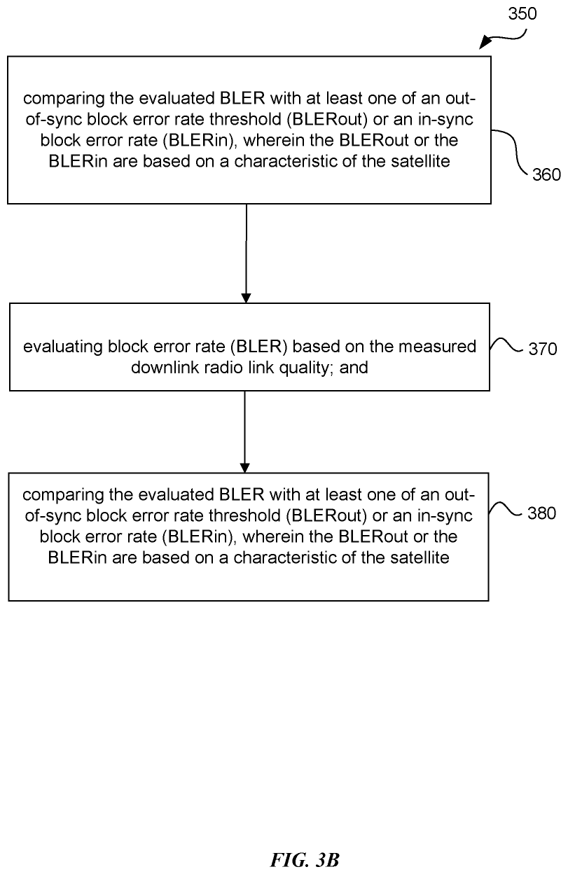

FIG. 3A illustrates a flowchart diagram of a method 300 for radio resource management in a non-terrestrial network, in accordance with aspects of the present disclosure. Step 310 includes receiving an indication of a service stop time of connectivity between the UE and the satellite within the wireless communication network.

Step 320 includes monitoring one or more inter-frequency or inter-RAT carriers in the wireless communication network.

Step 330 includes based on the monitoring, switching to another connection in the wireless communication network using one of the one or more inter-frequency or inter-RAT carriers.

FIG. 3B illustrates a flowchart diagram of a method 350 for radio link monitoring in a non-terrestrial network, in accordance with aspects of the present disclosure. Step 360 includes measuring downlink radio link quality of the connection during an evaluation period.

Step 370 includes evaluating block error rate (BLER) based on the measured downlink radio link quality.

Step 380 includes comparing the evaluated BLER with at least one of an out-of-sync block error rate threshold (BLERout) or an in-sync block error rate (BLERin), wherein the BLERout or the BLERin are based on a characteristic of the satellite.

### Exemplary Computer System

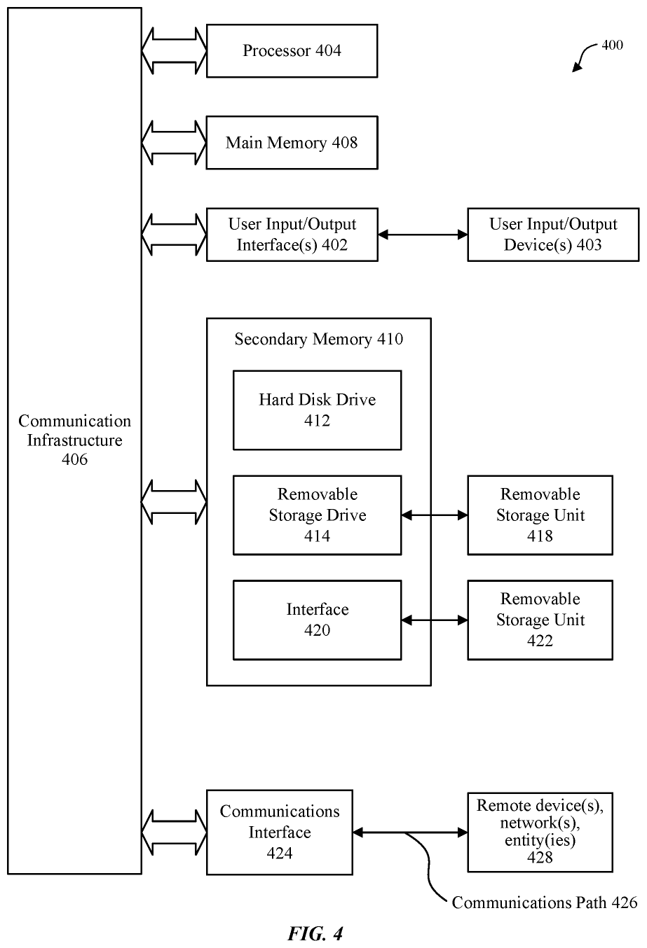

Various aspects can be implemented, for example, using one or more computer systems, such as computer system 400 shown in FIG. 4. Computer system 400 can be any well-known computer capable of performing the functions described herein such as devices 101, 103, 105 of FIG. 1, or 200 of FIG. 2. Computer system 400 includes one or more processors (also called central processing units, or CPUs), such as a processor 404. Processor 404 is connected to a communication infrastructure 406 (e.g., a bus.) Computer system 400 also includes user input/output device(s) 403, such as monitors, keyboards, pointing devices, etc., that communicate with communication infrastructure 406 through user input/output interface(s) 402. Computer system 400 also includes a main or primary memory 408, such as random access memory (RAM). Main memory 408 may include one or more levels of cache. Main memory 408 has stored therein control logic (e.g., computer software) and/or data.

Computer system 400 may also include one or more secondary storage devices or memory 410. Secondary memory 410 may include, for example, a hard disk drive 412 and/or a removable storage device or drive 414. Removable storage drive 414 may be a floppy disk drive, a magnetic tape drive, a compact disk drive, an optical storage device, tape backup device, and/or any other storage device/drive.

Removable storage drive 414 may interact with a removable storage unit 418. Removable storage unit 418 includes a computer usable or readable storage device having stored thereon computer software (control logic) and/or data. Removable storage unit 418 may be a floppy disk, magnetic tape, compact disk, DVD, optical storage disk, and/any other computer data storage device. Removable storage drive 414 reads from and/or writes to removable storage unit 418 in a well-known manner.

According to some aspects, secondary memory 410 may include other means, instrumentalities or other approaches for allowing computer programs and/or other instructions and/or data to be accessed by computer system 400. Such means, instrumentalities or other approaches may include, for example, a removable storage unit 422 and an interface 420. Examples of the removable storage unit 422 and the interface 420 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 400 may further include communication or network interface 424. Communication interface 424 enables computer system 400 to communicate and interact with any combination of remote devices, remote networks, remote entities, etc. (individually and collectively referenced by reference number 428). For example, communication interface 424 may allow computer system 400 to communicate with remote devices 428 over communications path 426, which may be wired and/or wireless, and may include any combination of LANs, WANs, the Internet, etc. Control logic and/or data may be transmitted to and from computer system 400 via communication path 426.

The operations in the preceding aspects can be implemented in a wide variety of configurations and architectures. Therefore, some or all of the operations in the preceding aspects may be performed in hardware, in software or both. In some aspects, a tangible, non-transitory apparatus or article of manufacture includes a tangible, non-transitory computer useable or readable medium having control logic (software) stored thereon is also referred to herein as a computer program product or program storage device. This includes, but is not limited to, computer system 400, main memory 408, secondary memory 410 and removable storage units 418 and 422, as well as tangible articles of manufacture embodying any combination of the foregoing. Such control logic, when executed by one or more data processing devices (such as computer system 400), causes such data processing devices to operate as described herein.

Based on the teachings contained in this disclosure, it will be apparent to persons skilled in the relevant art(s) how to make and use aspects of the disclosure using data processing devices, computer systems and/or computer architectures other than that shown in FIG. 4. In particular, aspects may operate with software, hardware, and/or operating system implementations other than those described herein.

It is to be appreciated that the Detailed Description section, and not the Summary and Abstract sections, is intended to be used to interpret the claims. The Summary and Abstract sections may set forth one or more, but not all, exemplary aspects of the disclosure as contemplated by the inventor(s), and thus, are not intended to limit the disclosure or the appended claims in any way.

While the disclosure has been described herein with reference to exemplary aspects for exemplary fields and applications, it should be understood that the disclosure is not limited thereto. Other aspects and modifications thereto are possible, and are within the scope and spirit of the disclosure. For example, and without limiting the generality of this paragraph, aspects are not limited to the software, hardware, firmware, and/or entities illustrated in the figures and/or described herein. Further, aspects (whether or not explicitly described herein) have significant utility to fields and applications beyond the examples described herein.

Aspects have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. In addition, alternative aspects may perform functional blocks, steps, operations, methods, etc. using orderings different from those described herein.

References herein to “one aspect,” “an aspect,” “an example aspect,” or similar phrases, indicate that the aspect described may include a particular feature, structure, or characteristic, but every aspects may not necessarily include the particular feature, structure, or characteristic. Moreover, such phrases are not necessarily referring to the same aspect. Further, when a particular feature, structure, or characteristic is described in connection with an aspect, it would be within the knowledge of persons skilled in the relevant art(s) to incorporate such feature, structure, or characteristic into other aspects whether or not explicitly mentioned or described herein. The breadth and scope of the disclosure should not be limited by any of the above-described exemplary aspects, but should be defined only in accordance with the following claims and their equivalents.

As described above, aspects of the present technology may include the gathering and use of data available from various sources, e.g., to improve or enhance functionality. The present disclosure contemplates that in some instances, this gathered data may include personal information data that uniquely identifies or can be used to contact or locate a specific person. Such personal information data can include demographic data, location-based data, telephone numbers, email addresses, Twitter ID's, home addresses, data or records relating to a user's health or level of fitness (e.g., vital signs measurements, medication information, exercise information), date of birth, or any other identifying or personal information. The present disclosure recognizes that the use of such personal information data, in the present technology, may be used to the benefit of users.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should only occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of, or access to, certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates aspects in which users selectively block the use of, or access to, personal information data. That is, the present disclosure contemplates that hardware and/or software elements can be provided to prevent or block access to such personal information data. For example, the present technology may be configurable to allow users to selectively “opt in” or “opt out” of participation in the collection of personal information data, e.g., during registration for services or anytime thereafter. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure may broadly cover use of personal information data to implement one or more various disclosed aspects, the present disclosure also contemplates that the various aspects can also be implemented without the need for accessing such personal information data. That is, the various aspects of the present technology are not rendered inoperable due to the lack of all or a portion of such personal information data.

1. A method by a user equipment (UE) for radio resource measurement (RRM) in an idle mode or an inactive mode in a wireless communication network having a satellite, the method comprising:
receiving an indication of a service stop time of connectivity between the UE and the satellite within the wireless communication network;
measuring one or more inter-frequency or inter-RAT carriers in the wireless communication network; and
based on the measurement results, switching to another connection in the wireless communication network using one of the one or more inter-frequency or inter-RAT carriers.

2. The method of claim 1, wherein the one or more inter-frequency or inter-RAT carriers are higher priority inter-frequency and inter-RAT carriers in the wireless communication network.

3. The method of claim 1, wherein the one or more inter-frequency or inter-RAT carriers are indicated to the UE by the wireless communications network, or are provided to the UE based on a wireless communication network specification.

4. The method of claim 1, wherein the one or more inter-frequency or inter-RAT carriers are selected based on a type of satellites in the wireless communication network, the type including a geostationary satellite, a low earth orbit (LEO)-earth-fixed satellite or a LEO-earth-moving satellite.

5. The method of claim 1, wherein the satellite is a serving satellite, and wherein the switching is further based on distance criteria, the distance criteria including one or more distance margins, a first distance between the UE and the serving satellite, and a second distance between the UE and a neighboring satellite.

6. The method of claim 5, wherein the one or more distance margins are further based on at least one of a global navigation satellite system (GNSS) estimation error or a satellite position estimation error, or a type of satellite, the type of satellite being one of a geostationary satellite, a low earth orbit (LEO)-earth-fixed satellite or a LEO-earth-moving satellite.

7. The method of claim 1, further comprising:
searching one or more layers of higher priority, the one or more layers of higher priority being described in system information (SI) received by the UE,
wherein the searching is performed at least once in a satellite-specific search period, the satellite-specific search period being reduced based on a type of satellite, the type of satellite being one of a geostationary satellite, a low earth orbit (LEO)-earth-fixed satellite or a LEO-earth-moving satellite.

8. A method by a user equipment (UE) for radio link monitoring (RLM) of a connection with a satellite in a wireless communication network, the method comprising:
measuring downlink radio link quality of the connection during an evaluation period;
evaluating block error rate (BLER) based on the measured downlink radio link quality; and
comparing the evaluated BLER with at least one of an out-of-sync block error rate threshold (BLERout) or an in-sync block error rate (BLERin), wherein the BLERout or the BLERin are based on a characteristic of the satellite.

9. The method of claim 8, wherein the evaluation period is based on a speed of the satellite, or a type of the satellite, the type of the satellite being one of a geostationary satellite, a low earth orbit (LEO)-earth-fixed satellite or a LEO-earth-moving satellite.

10. The method of claim 8, wherein the characteristic of the satellite is at least one of a speed of the satellite, or a type of the satellite, the type of the satellite being one of a geostationary satellite, a low earth orbit (LEO)-earth-fixed satellite or a LEO-earth-moving satellite.

11. A user equipment (UE) comprising:
a radio frequency (RF) receiver configured to receive, via an antenna:
an indication of a service stop time of connectivity between the UE and the satellite within the wireless communication network; and
processing circuitry coupled to the RF receiver, the processing circuitry configured to:
measure one or more inter-frequency or inter-RAT carriers in the wireless communication network; and
based on the measurement results, switch to another connection in the wireless communication network using one of the one or more inter-frequency or inter-RAT carriers.

12. The UE of claim 11, wherein the one or more inter-frequency or inter-RAT carriers are higher priority inter-frequency and inter-RAT carriers in the wireless communication network.

13. The UE of claim 11, wherein the one or more inter-frequency or inter-RAT carriers are indicated to the UE by the wireless communications network, or are provided to the UE based on a wireless communication network specification.

14. The UE of claim 11, wherein the one or more inter-frequency or inter-RAT carriers are selected based on a type of satellites in the wireless communication network, the type including a geostationary satellite, a low earth orbit (LEO)-earth-fixed satellite or a LEO-earth-moving satellite.

15. The UE of claim 11, wherein the satellite is a serving satellite, and wherein the switching is further based on distance criteria, the distance criteria including one or more distance margins, a first distance between the UE and the serving satellite, and a second distance between UE and a neighboring satellite.

16. UE of claim 15, wherein the one or more distance margins are further based on at least one of a global navigation satellite system (GNSS) estimation error or a satellite position estimation error, or a type of satellite, the type of satellite being one of a geostationary satellite, a low earth orbit (LEO)-earth-fixed satellite or a LEO-earth-moving satellite.

17. The UE of claim 11, wherein the processing circuitry is further configured to search one or more layers of higher priority, the one or more layers of higher priority being described in system information (SI) received by the UE,
wherein the searching is performed at least once in a satellite-specific search period, the satellite-specific search period being reduced based on a type of satellite, the type of satellite being one of a geostationary satellite, a low earth orbit (LEO)-earth-fixed satellite or a LEO-earth-moving satellite.

18-20. (canceled)
